(19) United States
(12) Patent Application Publication
(10) Pub. No.: US 2023/0199895 A1
(43) Pub. Date: Jun. 22, 2023

(54) METHODS AND APPARATUS FOR DATA TRANSMISSION IN NEW RADIO (NR) INACTIVE STATE

(71) Applicant: MediaTek Singapore Pte. Ltd., Singapore (SG)

(72) Inventors: Yuanyuan Zhang, Beijing (CN); CHIA-CHUN HSU, Hsinchu City (TW)

(21) Appl. No.: 18/171,876

(22) Filed: Feb. 21, 2023

Related U.S. Application Data
(63) Continuation of application No. PCT/CN2021/118199, filed on Sep. 14, 2021.
Application No. PCT/CN2021/118199 is a continuation of application No. PCT/CN2020/115129, filed on Sep. 14, 2020.

(30) Foreign Application Priority Data
Sep. 14, 2020 (WO) PCT/CN2020/115129
Sep. 14, 2021 (WO) PCT/CN2021/118199

(51) Int. Cl. H04W 76/20; H04W 72/1263; H04W 74/08

(52) U.S. Cl. CPC H04W 76/20; H04W 72/1263; H04W 74/0833

(57) ABSTRACT

Apparatus and methods are provided for initiating INACTIVE small data transmission (ISDT). In one novel aspect, the UE verifies one or more sets of conditions to select an ISDT initiation procedure. The UE first verifies that a set of ISDT conditions are met and selects an ISDT initiation procedure based on one or more sets of selection conditions, otherwise, the UE goes to the CONNECTED state. In one embodiment, the ISDT conditions comprises a data volume is smaller than or equal to a preconfigured ISDT data volume threshold, the UE has a valid Inactive AS context, no fallback indication has been received, and ISDT is supported by the wireless network. In another embodiment, the ISDT condition further includes the RSRP is greater than or equal to a preconfigured RSRP threshold. In one embodiment, the ISDT initiation procedures comprises: RRC-based RA procedure, RRC-less RA procedure, RRC-based CG, and RRC-less CG procedure.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2021/118199, entitled “Apparatus and methods to initiate small data transmission in NR Inactive State,” filed on Sep. 14, 2021. International application No. PCT/CN2021/118199, in turn, is filed under 35 U.S.C. § 111(a) and is based on and hereby claims priority under 35 U.S.C. § 120 and § 365(c) from International Application No. PCT/CN2020/115129, titled “Apparatus and methods to initiate small data transmission in NR Inactive State,” with an international filing date of Sep. 14, 2020. The disclosure of each of the foregoing documents is incorporated herein by reference.

### TECHNICAL FIELD

The disclosed embodiments relate generally to wireless communication, and, more particularly, to initiate small data transmission in new radio (NR) INACTIVE state.

### BACKGROUND

The fifth generation (5G) radio access technology (RAT) will be a key component of the modern access network. It will address high traffic growth, energy efficiency and increasing demand for high-bandwidth connectivity. It will also support massive numbers of connected devices and meet the real-time, high-reliability communication needs of mission-critical applications. The 5G network introduces RRC INACTIVE state to reduce control plane and user plane latency. In the RRC INACTIVE state, the UE is always connected from the core network (CN) aspect so that the transition from the INACTIVE state to the CONNECTED state is more efficiency than from the IDLE state to the CONNECTED. However, the UE needs to perform state transition from INACTIVE to CONNECTED state and completes connection resume procedures first for any DL and UL data. The data transmission and reception are performed in the CONNECTED state. Connection setup and subsequently release to INACTIVE state happens for each data transmission. The transition comprises extensive signaling sequence between the UE and the network. When the amount of data that wireless devices exchange with the network is small and the data transmission is usually not urgent enough to justify the high battery consumption required to handle all the signaling involved in the legacy INACTIVE-to-CONNECTED transition. The initiation procedure for the small data transmission in the UE INACTIVE state is a new challenge to enable the more efficient small data transmission in the INACTIVE state.

Improvements are required to define initiation of small data transmission in the UE INACTIVE state more efficiently.

### SUMMARY

Apparatus and methods are provided for initiating INACTIVE small data transmission (ISDT) in the wireless network. In one novel aspect, the UE verifies one or more sets of conditions to select an ISDT initiation procedure and initiates ISDT with the selected procedure. The UE first verifies that a set of ISDT conditions are met to select an ISDT initiation procedure, otherwise, the UE goes to the CONNECTED state for the data transmission. In one embodiment, the ISDT conditions comprises, a data volume is smaller than or equal to a preconfigured data volume threshold, the UE has a valid Inactive AS context, no fallback indication has been received, and ISDT is supported by the wireless network. In another embodiment, the ISDT condition further includes the RSRP is greater than or equal to a preconfigured RSRP threshold. Different sets of conditions are defined for different procedures. RRC-less CG conditions include UE has valid CG configuration; UE has valid time alignment value; Data volume is smaller than or equal to the value configured for CG; No need of security update; and No need of reconfiguration. RRC-based CG procedure condition include UE has valid CG configuration; UE has valid time alignment value; and Data volume is smaller than or equal to the value configured for CG. RRC-less RA conditions include the data volume is smaller than or equal to the value configured for ISDT; no need of security update; no need of reconfiguration; and RRC-less ISDT is supported. RRC-based RA conditions include the data volume is smaller than or equal to the value configured for ISDT; and the ISDT is supported. In one embodiment, when UE initiates ISDT, it further verifies the following conditions: the upper layer requests data transmission for the RBs configured with ISDT; UE has valid UE Inactive AS context; and no fallback indication has been received from lower layers. In yet another embodiment, the ISDT condition further includes the RSRP is greater than or equal to a preconfigured RSRP threshold.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless communication network that supports initiating ISDT and performing small data transmission in INACTIVE state.

FIG. 2 illustrates an exemplary NR wireless system with centralized upper layers of the NR radio interface stacks.

FIG. 3 illustrates an exemplary top-level flow diagram for initiation of ISDT.

FIG. 4 illustrates exemplary flow diagrams for ISDT initiation procedure options including RRC-based procedure, RRC-less procedure, RA procedure, and CG procedure.

FIG. 5 illustrates an exemplary flow diagram for the ISDT initiation procedure selection.

FIG. 6 illustrates an exemplary flow diagram for the ISDT initiation procedure selection when the RRC-less is not supported for ISDT.

FIG. 7 illustrates an exemplary ISDT initiation procedure selection flow chart with RRC-less supported or without RRC-less supported.

FIG. 8 illustrates exemplary flowcharts for ISDT initiation procedures including the RRC-less CG procedure, the RRC-based CG procedure, the RRC-less RA procedure, and the RRC-based RA procedure.

FIG. 9 illustrates exemplary diagrams for one-step selection of the ISDT initiation procedure based on one set of selection conditions corresponding to the possible ISDT initiation procedures.

FIG. 10 illustrates an exemplary data volume calculation for the ISDT initiation procedure selection.

FIG. 11 illustrates an exemplary flow chart for the selection of the ISDT initiation procedure.

### DETAILED DESCRIPTION

Reference will now be made in detail to some embodiments of the invention, examples of which are illustrated in the accompanying drawings.

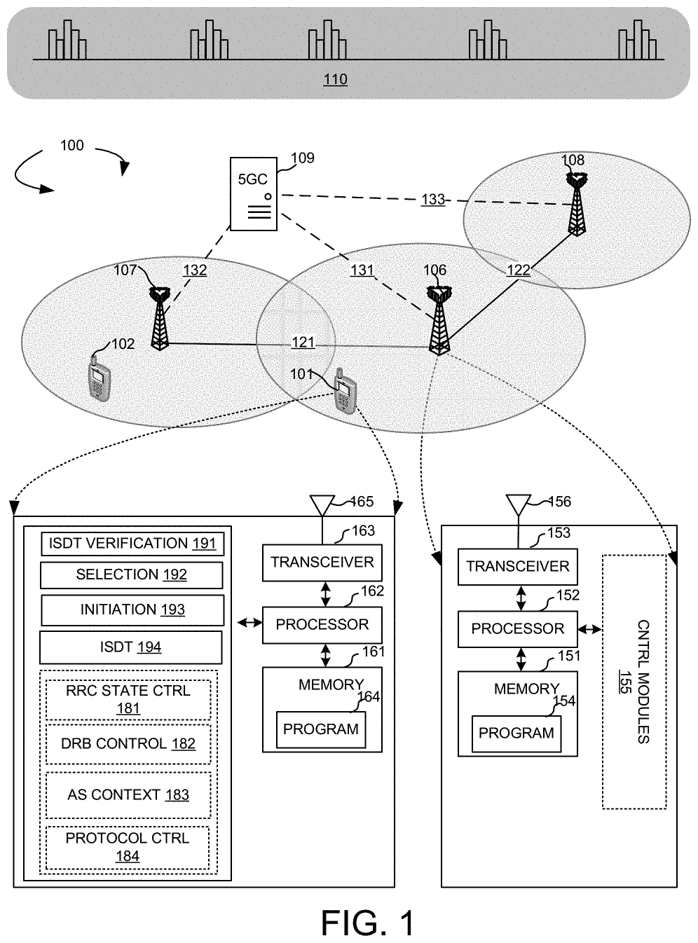

FIG. 1 is a schematic system diagram illustrating an exemplary wireless communication network 100 that supports initiating ISDT and performing small data transmission in INACTIVE state. Wireless communication network 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. As an example, base stations serve a number of mobile stations within a serving area, for example, a cell, or within a cell sector. In some systems, one or more base stations are coupled to a controller forming an access network that is coupled to one or more core networks. gNB 106, gNB 107 and gNB 108 are base stations in the wireless network, the serving area of which may or may not overlap with each other. As an example, user equipment (UE) 101 or mobile station 101 is in the serving area covered by gNB 106 and gNB 107. As an example, UE 101 or mobile station 101 is only in the service area of gNB 106 and connected with gNB 106. UE 102 or mobile station 102 is only in the service area of gNB 107 and connected with gNB 107. gNB 106 is connected with gNB 107 via Xn interface 121. gNB 106 is connected with gNB 108 via Xn interface 122. A 5G network entity 109 connects with gNB 106, 107, and 108 via NG connection 131, 132, and 133, respectively. In one embodiment, UE 101 is configured to be able to transmit data in the INACTIVE state without the transition to CONNECTED state.

In one novel aspect, the UE initiates data transmission and/or reception in the INACTIVE state. In one embodiment, the data transmission is INACTIVE small-data transmission (ISDT) as data bursts shown in a block 110. The NR network supports many services with infrequent and small-data packets. For example, traffic from instant messaging (IM) services, heartbeat/keep-alive traffic from IM/email clients and other apps and push notifications from various applications are the typical use cases of smart phone applications. For non-smartphone applications, traffic from wearables, sensors and smart meters/smart meter networks sending periodic meter readings are the typical use cases. For these small data shown in the block 110, the data transmission and/or reception are initiated in the INACTIVE state.

FIG. 1 further illustrates simplified block diagrams of a base station and a mobile device/UE for data transmission and reception in the INACTIVE state. FIG. 1 includes simplified block diagrams of a UE, such as UE 101. The UE has an antenna 165, which transmits and receives radio signals. An RF transceiver circuit 163, coupled with the antenna, receives RF signals from antenna 165, converts them to baseband signals, and sends them to a processor 162. In one embodiment, the RF transceiver 163 may comprise two RF modules (not shown). A first RF module is used for High Frequency (HF) transmitting and receiving, and the other RF module is used for different frequency bands transmitting and receiving which is different from the HF transceiver. RF transceiver 163 also converts received baseband signals from processor 162, converts them to RF signals, and sends out to antenna 165. Processor 162 processes the received baseband signals and invokes different functional modules to perform features in UE 101. Memory 161 stores program instructions and data 164 to control the operations of UE 101. The memory 161 also stores UE INACTIVE Access Stratum (AS) CONTEXT, which includes the current KgNB and KRRCint keys, the robust header compression (ROHC) state, the stored QoS flow to dedicated radio bearer (DRB) mapping rules, the cell radio network temporary identifier (C-RNTI) used in the source primary cell (PCell), the cellIdentity and the physical cell identity of the source PCell, and/or some other parameters. In one embodiment, the UE INACTIVE AS CONTEXT also has another set of parameters configured for data transmission in the INACTIVE state, which includes the configurations for physical layer and MAC layer. In one embodiment, the physical layer configuration includes pre-configured UL resources, which can be used for UL data transmission in the INACTIVE state. In one embodiment, the physical layer configuration includes an MAC configuration, e.g., MAC-CellGroupConfig. Antenna 165 sends uplink transmission and receives downlink transmissions to/from antenna 156 of gNB 106.

The UE also includes a set of control modules that carry out functional tasks. These control modules can be implemented by circuits, software, firmware, or a combination of them. An ISDT verification module 191 verifies a set of preconfigured ISDT conditions in the wireless network, wherein the UE is configured to perform small data transmission in a UE INACTIVE state when the set of preconfigured ISDT conditions is met. A selection module 192 selects an ISDT initiation procedure based on one or more sets of selection conditions, wherein the one or more sets of selection conditions comprise a set of selection conditions for a radio resource control (RRC) procedure and a set of selection conditions for a uplink (UL) resource obtaining procedure, and wherein the RRC procedure is one selecting from an RRC-based procedure and an RRC-less procedure, and the UL resource obtaining procedure is one selecting from a random access (RA) procedure and a configured grant (CG) procedure. An initiation module 193 initiates small data transmission in the UE INACTIVE state following the selected ISDT initiation procedure. An ISDT module 194 performs one or more small data transmissions in the UE INACTIVE state.

Other optional control modules can be configured for the UE, include a RRC state control module 181, a DRB control module 182, an AS context control module 183, and a protocol control module 184. The RRC state control module 181 controls UE RRC state according to network's command and UE conditions. UE RRC supports the following states, RRC_IDLE, RRC_CONNECTED and RRC_INACTIVE. In one embodiment, UE is configured to transmit UL data in INACTIVE with one or multiple shots to a network. In one embodiment, UL data transmission in INACTIVE is configured per DRB. UE can initiate data transmission for those DRBs when the total data amount for those DRBs arrives in the buffer is less than a threshold. In one embodiment, the network configures the threshold of data amount through system information or dedicated RRC signaling. The DRB control module 182 suspends or resumes the DRBs. In one embodiment, one or multiple particular DRBs are configured by network, whose data packets can be transmitted in INACTIVE. In one embodiment, the DRB is resumed when a burst of data is to be transmitted; the DRB is suspended when the transmission of data burst is finished. The INACTIVE AS CONTEXT control module 183 manages to store, restore, or release the UE INACTIVE AS CONTEXT. In one embodiment, the UE INACTIVE AS CONTEXT controller decides which parameters, or which set of parameters are restored according to whether UE initiate data transmission or not in INACTIVE state. In one embodiment, UE restores all the stored parameters including MAC configuration and physical layer configuration. The protocol control module 184 controls the establishment, re-establishment, release, reset, reconfiguration of the user plane protocols including packet data convergence protocol (PDCP), radio link control (RLC) and media access control (MAC). In one embodiment, the SDAP layer is optionally configured.

FIG. 1 further includes simplified block diagrams of a gNB, such as gNB 106. gNB 106 has an antenna 156, which transmits and receives radio signals. An RF transceiver circuit 153, coupled with the antenna 156, receives RF signals from antenna 156, converts them to baseband signals, and sends them to a processor 152. RF transceiver 153 also converts received baseband signals from processor 152, converts them to RF signals, and sends out to antenna 156. Processor 152 processes the received baseband signals and invokes different functional modules to perform features in gNB 106. Memory 151 stores program instructions and data to control the operations of gNB2. The memory 151 also stores UE INACTIVE AS CONTEXT. In one embodiment, the UE INACTIVE AS CONTEXT also has another set of parameters configured supporting data transmission in INACTIVE, which includes the configurations for physical layer and MAC layer. The gNB 106 also includes a set of control modules 155 that carry out functional tasks to communicate with mobile stations. The set of control modules 155 includes a RRC state controller, a DRB controller, an INACTIVE AS CONTEXT controller, and a protocol controller. The RRC state controller controls UE RRC state by sending command to UE or providing configuration for the conditions. The DRB controller suspends or resumes the DRBs of a UE. In one embodiment, the DRB is resumed when a burst of data is to be transmitted; the DRB is suspended when the transmission of data burst is finished. The INACTIVE AS CONTEXT controller manages to store, restore, or release the UE INACTIVE AS CONTEXT. The protocol controller controls the establishment, re-establishment, release, reset, configuration of the user plane protocols including PDCP, RLC and MAC. In one embodiment, the SDAP layer is optionally configured. The gNB also includes multiple function modules. A random access (RA) module, which performs random access for a UE. It supports 2-step RA procedure and 4-step RA procedure. A Configured Grant (CG) module, which receives data on the pre-configured PUSCH resources. An RRC-based module, which receives ISDT from UE with RRC messages/procedures, i.e., RRCResumeRequest. An RRC-less module, which receives ISDT from UE without RRC messages.

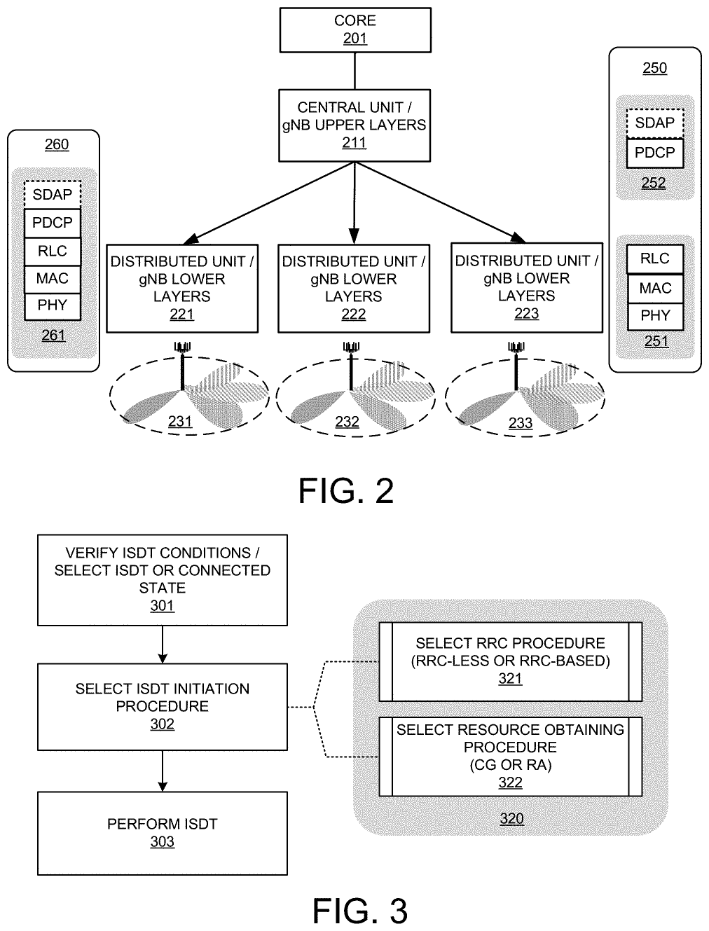

FIG. 2 illustrates an exemplary NR wireless system with centralized upper layers of the NR radio interface stacks and UE protocol stacks with multicast protocols and unicast protocols. Different protocol split options between central unit (CU) and distributed unit (DU) of gNB may be possible. The functional split between the CU and DU of gNB may depend on transport layer. Low performance transport between the CU and DU of gNB can enable higher protocol layers of the NR radio stacks to be supported in the CU, since the higher protocol layers have lower performance requirements on the transport layer in terms of bandwidth, delay, synchronization, and jitter. In one embodiment, SDAP and PDCP layers are located in the CU, while RLC, MAC and PHY layers are located in the DU. A core unit 201 is connected with a central unit 211 with gNB upper layer 252. In one embodiment 250, gNB upper layer 252 includes the PDCP layer and optionally the SDAP layer. Central unit 211 connects with distributed units 221, 222, and 221. Distributed units 221, 222, and 223 each corresponds to a cell 231, 232, and 233, respectively. The DUs, such as 221, 222 and 223 includes gNB lower layers 251. In one embodiment, gNB lower layers 251 include the PHY, MAC and the RLC layers. In another embodiment 260, each gNB has a protocol stack 261 including SDAP, PDCP, RLC, MAC and PHY layers.

FIG. 3 illustrates an exemplary top-level flow diagram for initiation of ISDT. UE initiates data transmission in the INACTIVE state. At step 301, the UE verifies whether a preconfigured set of ISDT conditions is met to decide whether to initiate the ISDT or go to the CONNECTED state for the data transmission. At step 302, if step 301 verifies the set of preconfigured ISDT conditions is met, the UE selects an ISDT initiation procedure. The UE selects the ISDT initiation procedure based on one or more sets of selection conditions. According to an embodiment 320, the sets of selection conditions comprise a set of selection conditions for a radio resource control (RRC) procedure 321 and a set of selection conditions for an uplink (UL) resource obtaining procedure 322. Selection 321 selects an RRC procedure from an RRC-based procedure and an RRC-less procedure. Selection 322 selects an UL resource obtaining procedure is one selecting from a random access (RA) procedure and a configured grant (CG) procedure. The ISDT initiation procedure is one selecting from an RRC-based RA procedure, an RRC-based CG procedure, an RRC-less RA procedure, and an RRC-less CG procedure. Upon initiating the ISDT using the selected ISDT initiation procedure, at step 303, the UE performs ISDT.

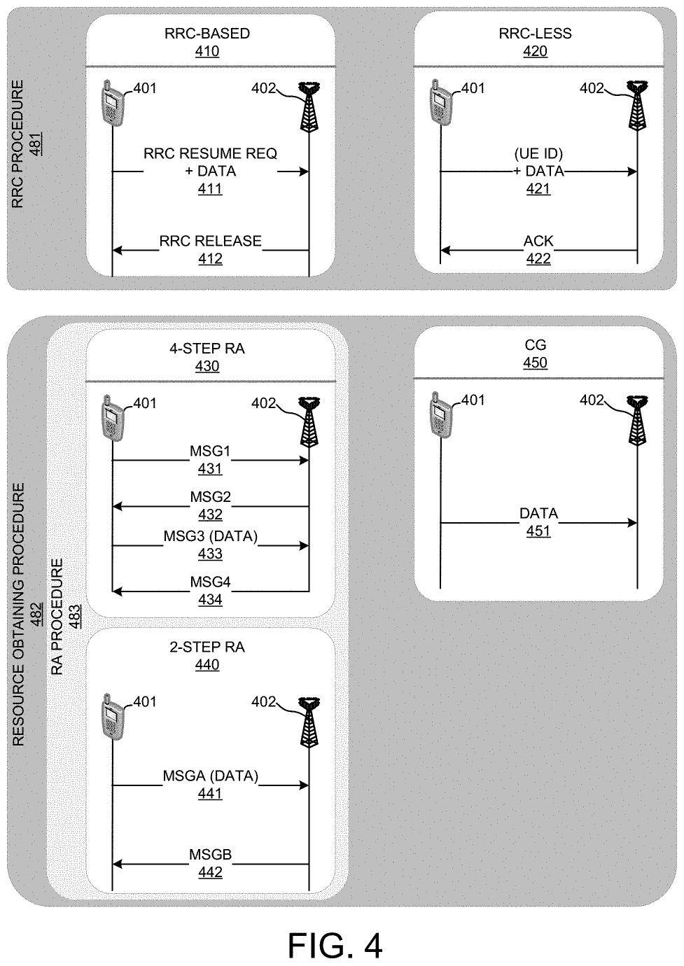

FIG. 4 illustrates exemplary flow diagrams for ISDT initiation procedure options including RRC-based procedure, RRC-less procedure, RA procedure, and CG procedure. Upon determining the ISDT is selected, the UE 401, communicates with gNB 402, selects an initiation procedure for the ISDT. UE 401 selects a RRC procedure 481 including an RRC-based procedure 410 and an RRC-less procedure 420. The UE 401 also selects a resource obtaining procedure 482, which includes an RA procedure 483 and a CG procedure 450. RA procedure 483 includes a 4-step RA procedure 430 and a 2-step RA procedure 440.

In RRC-based procedure 410, the upper layer requests the resume of a suspended RRC connection when there is UL data for the RBs configured with ISDT. UE transmits UL data during the RRC Resume procedure. In one embodiment, UE 401, at step 411, transmits UL data with RRCResumeRequest message. At step 412, the UE receives RRCRelease message with suspendConfig. Subsequently, UE 401 goes to INACTIVE state after data transmission completion. In another embodiment, the upper layer requests direct data transmission without resume of a suspended RRC connection when there is UL data for the RBs configured with ISDT. In RRC-less procedure 420, UE 401, at step 421, transmits UL data directly without any RRC message. At step 422, UE 401 receives a L1 or L2 acknowledgement as the response.

The UE also selects an initiation procedure for UL resources including an RA procedure and a CG procedure. If UL data is transmitted through RA procedure, the UL data is transmitted by Msg3 (in 4-step RA)/MsgA (in 2-step RA). If UL data is transmitted through CG procedure, the UL data is transmitted through configured UL grant. The UL grant is provided by a dedicated configuration through an RRC message by the network. In 4-step RA procedure 430, UE 401, at step 431, sends MSG1. At step 432, UE 401 receives MSG2 from gNB 402. At step 433, UE 401 sends MSG3 with data to gNB 402. At step 434, UE 401 receives MSG4 from gNB 402. In 2-step procedure 440, UE 401 sends MSGA with data to gNB 402 at step 441. At step 442, UE 401 receives MSGB from gNB 402. In CG procedure 450, at step 451, UE 401 sends UL data through the resource provided by the UL grant.

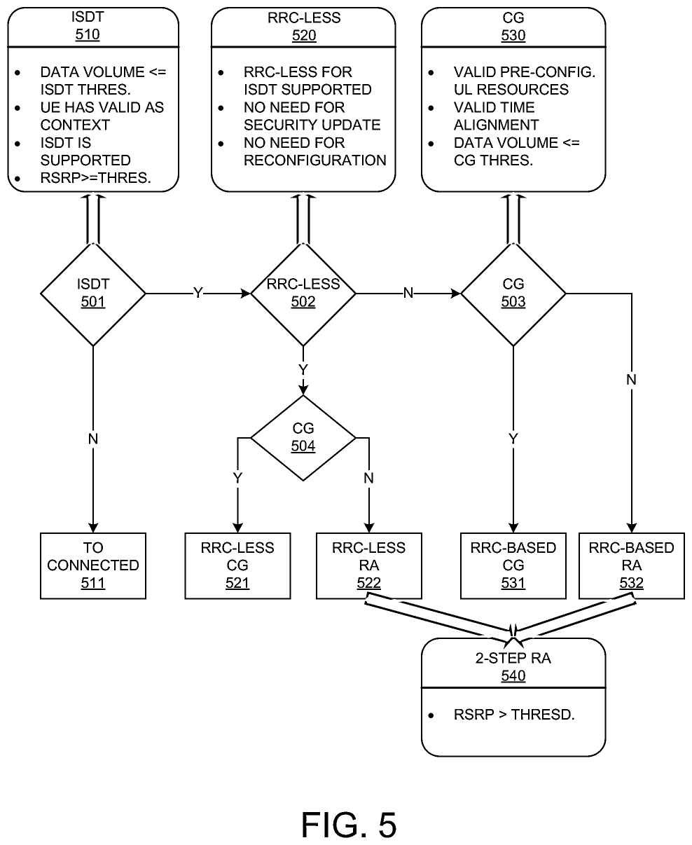

FIG. 5 illustrates an exemplary flow diagram for the ISDT initiation procedure selection. At step 501, UE determines whether to initiate ISDT procedure or resume RRC connection with legacy procedure, i.e., transfer to CONNECTED state for data transmission based on a set of predefined ISDT conditions 510. The ISDT conditions 510 include UL data for the RBs configured with ISDT, a data volume is smaller than or equal to a preconfigured ISDT data volume threshold, the UE has a valid Inactive AS context, no fallback indication has been received, and ISDT is supported by the wireless network. In other embodiment, the ISDT conditions further include a reference signal received power (RSRP) is greater than or equal to a preconfigured RSRP threshold. The set of preconfigured ISDT conditions is also called the ISDT common conditions, which applies to all ISDT initiation procedures. If step 501 determines the set of predefined ISDT conditions is met, UE initiates ISDT. Otherwise, at step 511, UE resumes RRC connection and transfers to RRC_CONNECTED for data transmission. If step 501 determines to initiate ISDT, the UE determines whether to use RRC-less or RRC-based procedure at step 502, and whether to use CG or RA procedure at step 503. The sequence of step 502 and step 503 is interchangeable. At step 502, the UE determines whether an RRC-less procedure is to be used based on selection conditions 520. Selection conditions 520 include RRC-less for ISDT is supported by the network, no security update is needed, and no reconfiguration is needed. According to some embodiments, security update comprises security configuration (for example, security key and algorithm) update. If step 502 determines RRC-less procedure is selected, the UE determines whether to use CG or RA procedure at step 504. If step 502 determines RRC-based procedure is selected, at step 503, the UE determines whether to carry ISDT through RA or CG based on selection conditions 530, including valid preconfigured UL resources, valid time alignment, and a data volume is smaller than or equal to a preconfigured CG data volume threshold. If step 503 determines “yes”, the UE selects RRC-based CG procedure for ISDT initiation at step 531. Otherwise, the UE selects RRC-based RA procedure for the ISDT initiation at step 532. Similarly, if step 504 determines “yes” according to selection conditions 530, the UE selects RRC-less CG procedure for ISDT initiation at step 521. If step 504 determines “no” according to selection conditions 530, the UE selects RRC-less RA procedure for ISDT initiation at step 522. In one embodiment, the UE further determines whether a 2-step or 4-step RA is to be used when the UE selects the RA procedure for ISDT initiation, such as steps 522 and 532. The UE selects the 2-step RA procedure for the ISDT initiation when a RSRP is larger than a preconfigured two-step RSRP threshold.

The order of steps 502 and 503 can be changed, i.e., UE selects between RA and CG first and then selects between RRC-based and RRC-less schemes. In one embodiment, the preconfigured ISDT data volume threshold for ISDT initiation and the preconfigured CG data volume threshold for transmission by CG is the same. In another embodiment, the preconfigured CG data volume threshold for transmission by CG is a value of TB size. UE compares between the sum of TB size for the total data volume and the maximum TB size configured by the network. After the two steps of selection, UE initiates ISDT with the combination of the two selections including RRC-based RA procedure, RRC-less RA procedure, RRC-based CG procedure, and RRC-less CG procedure.

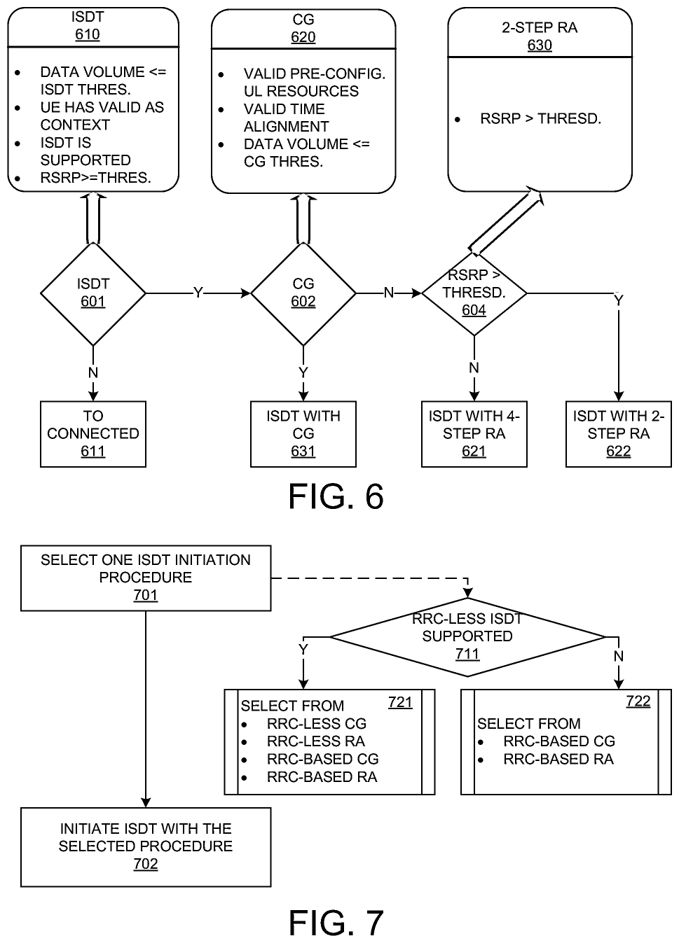

FIG. 6 illustrates an exemplary flow diagram for the ISDT initiation procedure selection when the RRC-less is not supported for ISDT. In one embodiment, ISDT with RRC message is always required, and the selection between RRC-based and RRC-less initiation is not needed. The ISDT initiation procedure is selected from the RRC-based RA procedure and the RRC-based CG procedure when the RRC-less procedure for ISDT is not supported by the wireless network. At step 601, the UE determines whether to initiate ISDT procedure or transfer to CONNECTED state for data transmission based on a set of predefined ISDT conditions 610. The ISDT conditions 610 include UL data for the RBs configured with ISDT, a data volume is smaller than or equal to a preconfigured ISDT data volume threshold, the UE has a valid Inactive AS context, no fallback indication has been received, and ISDT is supported by the wireless network. In other embodiment, the ISDT conditions 610 further include a reference signal received power (RSRP) is greater than or equal to a preconfigured RSRP threshold. The set of preconfigured ISDT conditions is also called the ISDT common conditions, which applies to all ISDT initiation procedures. If step 601 determines the set of predefined ISDT conditions is met, UE initiates ISDT. Otherwise, at step 611, UE resumes RRC connection and transfers to RRC_CONNECTED for data transmission. Since the RRC-less ISDT is not support, upon determined ISDT is to be used, the UE selects either a CG or a RA procedure for ISDT initiation. At step 602, the UE determines whether a preconfigured set of CG conditions 620 is met. CG conditions 620 include valid preconfigured UL resources, valid time alignment, and a data volume is smaller than or equal to a preconfigured CG data volume threshold. If step 602 determines “yes”, the UE selects the RRC-based CG procedure for the ISDT initiation. If step 602 determines “no”, the UE selects the RRC-based RA procedure for the ISDT initiation. In one embodiment, the UE further determines whether a 2-step RA or a 4-step RA procedure is to be used at step 604 based on a preconfigured 2-step RA condition 630, which includes a RSRP is larger than a preconfigured two-step RSRP threshold. If step 604 determines “yes”, the UE selects the RRC-based 2-step RA for the ISDT initiation, otherwise, the RRC-based 4-step RA for the ISDT initiation is selected.

FIG. 7 illustrates an exemplary ISDT initiation procedure selection flow chart with RRC-less supported or without RRC-less supported. At step 701, the UE selects one ISDT initiation procedure. At step 702, the UE initiates ISDT with the selected initiation procedure. In selecting the ISDT initiation procedure, the UE determines whether RRC-less ISDT is supported by the network at step 711. If RRC-less ISDT is supported by the network, the UE selects from list of ISDT initiation procedures 721 including the RRC-less CG procedure, the RRC-less RA procedure, the RRC-based CG procedure, and the RRC-based RA procedure. If RRC-less ISDT is not supported by the network, the UE selects from list of ISDT initiation procedures 722 including the RRC-based CG procedure and the RRC-based RA procedure.

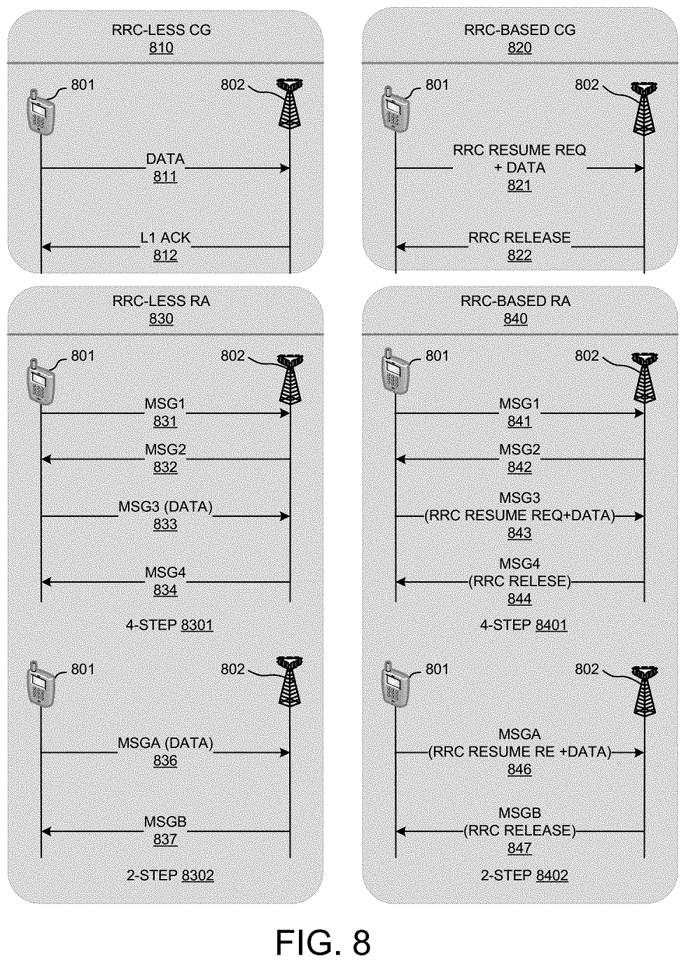

FIG. 8 illustrates exemplary flowcharts for ISDT initiation procedures including the RRC-less CG procedure, the RRC-based CG procedure, the RRC-less RA procedure, and the RRC-based RA procedure. UE 801 in a wireless network with a gNB 802, selects an ISDT initiation procedure including the RRC-less CG procedure 810, the RRC-based CG procedure 820, the RRC-less RA procedure 830, which includes a 4-step procedure 8301, and a 2-step procedure 8302, and the RRC-based RA procedure 840, which includes a 4-step procedure 8401, and a 2-step procedure 8402.

For RRC-less CG procedure 810, UE 801, at step 811, transmits UL data directly without any RRC message. At step 812, UE 801 receives a L1 or L2 acknowledgement as the response from gNB 802. The UL data is transmitted based on the configured UL grant. The UL grant is provided through a dedicated configuration and RRC message by the network. For RRC-based CG procedure 820, the upper layer requests the resume of a suspended RRC connection when there is UL data for the RBs configured with ISDT. UE 801 transmits UL data during the RRC Resume procedure. In one embodiment, at step 821, UE 801 transmits UL data with RRCResumeRequest message through the configured UL resources. In one embodiment, at step 822, UE 801 receives RRCRelease message with suspendConfig later, which sends UE 801 to INACTIVE state after data transmission completion. In one embodiment, UE 801 receives a L1/L2 ACK as the response to the RRCResumeRequest, which sends UE 801 to INACTIVE state.

In RRC-less RA procedure 830, UE 801 transmits UL data directly without any RRC message. In one embodiment, the upper layer requests direct data transmission without resume of a suspended RRC connection when there is UL data for the RBs configured with ISDT. UE transmits the UL data in Msg3 (in 4-step RA)/MsgA (in 2-step RA). For the RRC-less 4-step RA procedure 8301, UE 801, at step 831, transmits MSG1 to gNB 802. At step 832, UE 801 receives MGS2 from gNB 802. At step 833, UE 801 sends MSG 3 with data to gNB 802. At step 834, UE 801 receives MSG4 from gNB 802. For the RRC-less 2-step RA procedure 8302, at step 836, UE 801 sends MSGA with data to gNB 802. At step 837, UE 801 receives MSGB from gNB 802.

In RRC-based RA procedure 840, the upper layer requests the resume of a suspended RRC connection when there is UL data for the RBs configured with ISDT. UE 801 transmits UL data during the RRC Resume procedure. In one embodiment, UE transmits UL data with RRCResumeRequest message in Msg3 (in 4-step RA)/MsgA (in 2-step RA). In one embodiment, UE receives RRCRelease message with suspendConfig in Msg4 (in 4-step RA)/MsgB (in 2-step RA), which sends UE to INACTIVE state after data transmission completion. For RRC-based 4-step RA procedure 8401, at step 841, UE 801 transmits MSG1 to gNB 802. At step 842, UE 801 receives MGS2 from gNB 802. At step 843, UE 801 sends MSG 3 with RRC Resume Request and data to gNB 802. At step 844, UE 801 receives MSG4 with RRC release message from gNB 802. For the RRC-less 2-step RA procedure 8402, at step 846, UE 801 sends MSGA with RRC Resume Request and data to gNB 802. At step 847, UE 801 receives MSGB with RRC Release from gNB 802. When the ISDT conditions are not met, the UE may transfer to the CONNECTED state to transmit the data packets. The upper layer requests the resume of a suspended RRC connection. The UE performs RRC connection resume procedure through RA procedure and transfers to CONNECTED. After that, UE starts UL data transmission. After completion of data transmission, RRCRelease message is received.

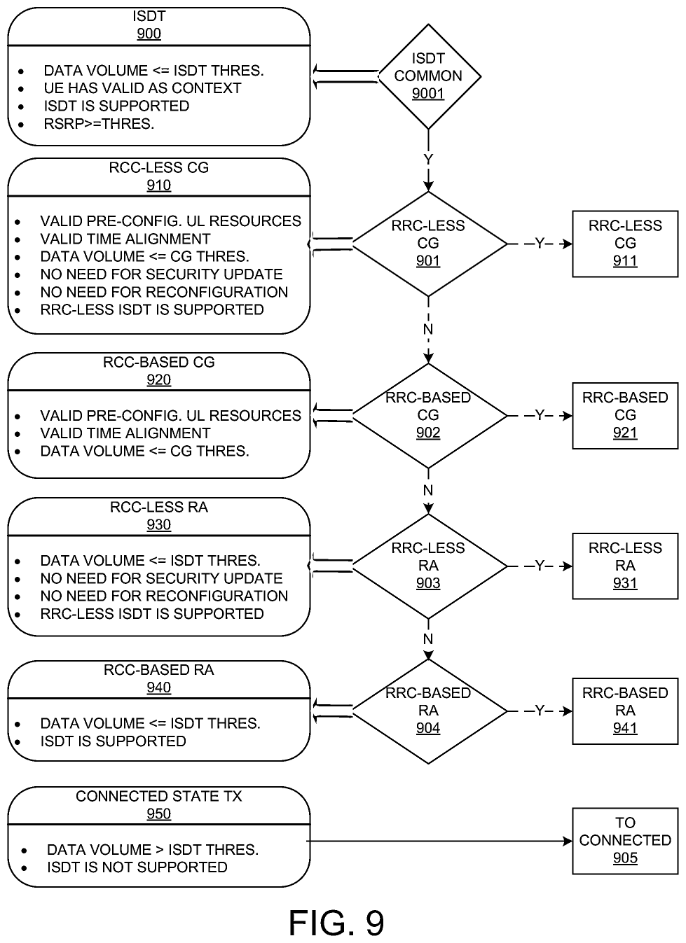

FIG. 9 illustrates exemplary diagrams for one-step selection of the ISDT initiation procedure based on a set of selection conditions corresponding to the possible ISDT initiation procedures. In order to initiate ISDT, the upper layer requests data transmission for the RBs configured with ISDT. UE checks the different set of conditions to determine to utilize which procedure to initiate ISDT. At step 9001, the UE determines if ISDT common conditions 900 are met. ISDT common conditions 900 include a data volume is smaller than or equal to a preconfigured data volume threshold, the UE has a valid Inactive AS context, no fallback indication has been received, and ISDT is supported by the wireless network. In another embodiment, ISDT common conditions 900 further comprises the RSRP is greater than or equal to a preconfigured RSRP threshold. At step 901, RRC-less CG procedure 911 is selected when ISDT conditions are met, and RRC-less CG conditions 910 are met. RRC-less CG conditions 910 include valid preconfigured UL resources, valid time alignment, a data volume is smaller than or equal to a preconfigured CG data volume threshold, and RRC-less ISDT is supported. At step 902, RRC-based CG procedure 921 is selected when ISDT conditions are met, and RRC-based CG conditions 920 are met. RRC-based CG conditions 920 include valid preconfigured UL resources, valid time alignment, and a data volume is smaller than or equal to a preconfigured CG data volume threshold. At step 903, an RRC-less RA procedure 931 is selected when ISDT conditions are met, and RRC-less RA conditions 930 are met. RRC-less RA conditions 930 include no security update is needed, and no reconfiguration is needed, and RRC-less ISDT is supported. At step 904, the RRC-based RA procedure 941 is selected when the ISDT conditions are met, and RRC-based RA conditions 940 are met. At step 905, UE goes to the CONNECTED state when the CONNECTED state transmission conditions 950 are met. CONNECTED state transmission conditions 950 include the data volume is greater than the preconfigured ISDT data volume threshold, and the ISDT is not supported by the network. Steps 901 through 905 can be performed in the exemplary order. The exemplary order gives RRC-less CG the highest priority. Any other orders of selection are available. The UE may be preconfigured with different preferences or priorities for the available ISDT initiation procedures. The preferences/priorities of the ISDT initiation procedures can be dynamically configured and changed as well.

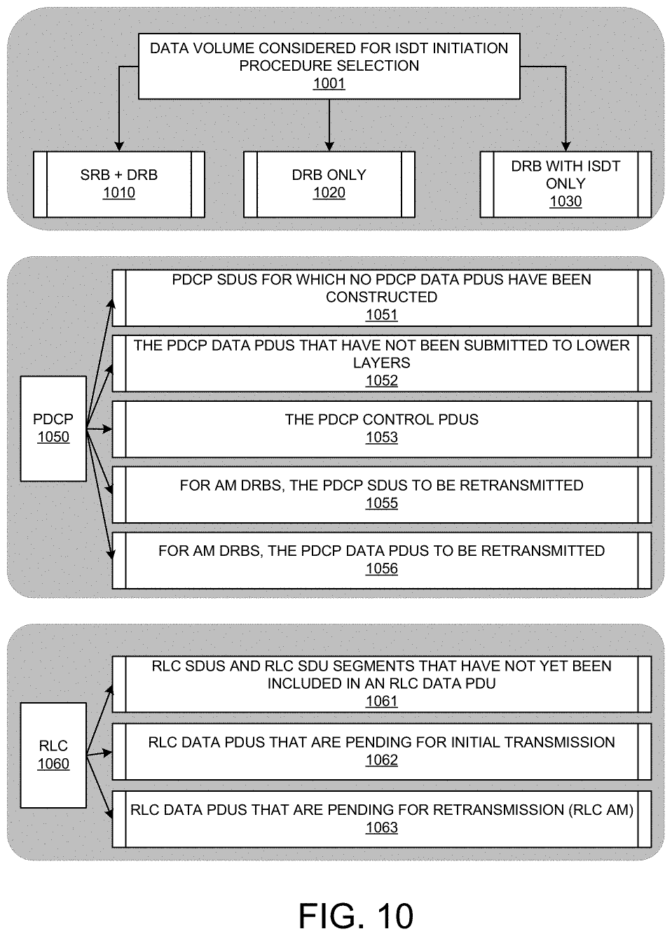

FIG. 10 illustrates an exemplary data volume calculation for the ISDT initiation procedure selection. At a first step 1001, the UE determines the data volume calculation for consideration of ISDT initiation procedure selection. In one embodiment 1010, the data volume calculation considers both signalling radio bearers (SRB) and dedicated radio bearers (DRBs). In one embodiment 1020, the data volume calculation only considers the DRBs. In one embodiment 1030, the data volume calculation only considers the DRBs configured for ISDT. For each RB, from PDCP 1050 aspect, the data volume considers: the PDCP SDUs for which no PDCP Data PDUs have been constructed 1051, the PDCP Data PDUs that have not been submitted to lower layers 1052, the PDCP Control PDUs 1053, for acknowledged mode (AM) DRBs, the PDCP SDUs to be retransmitted 1054, for AM DRBs, the PDCP Data PDUs to be retransmitted 1055. From the RLC 1060 aspect, the data volume considers RLC SDUs and RLC SDU segments that have not yet been included in an RLC data PDU 1061, RLC data PDUs that are pending for initial transmission 1062, and RLC data PDUs that are pending for retransmission (RLC AM) 1063.

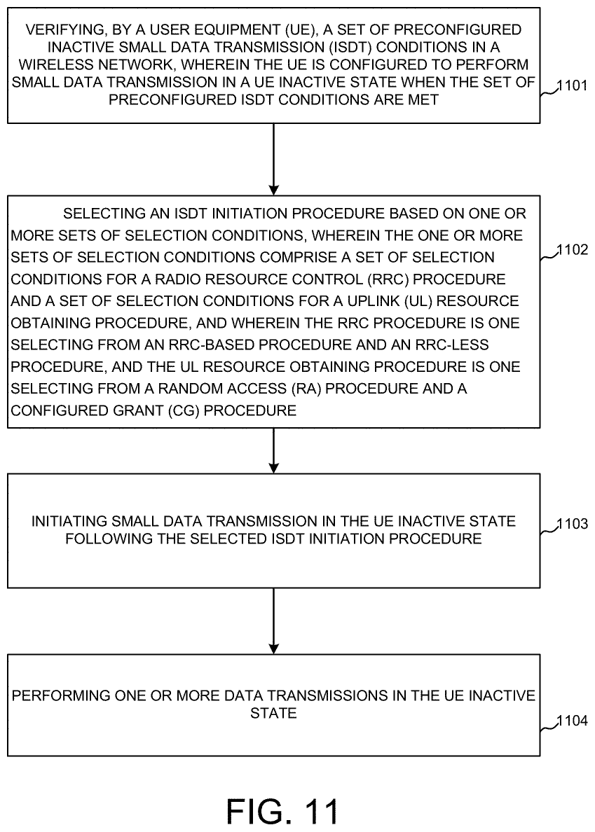

FIG. 11 illustrates an exemplary flow chart for the selection of the ISDT initiation procedure. At step 1101, the UE verifies a set of preconfigured inactive small data transmission (ISDT) conditions in a wireless network, wherein the UE is configured to perform small data transmission in a UE INACTIVE state when the set of preconfigured ISDT conditions are met. At step 1102, the UE selects an ISDT initiation procedure based on one or more sets of selection conditions, wherein the one or more sets of selection conditions comprise a set of selection conditions for a radio resource control (RRC) procedure and a set of selection conditions for a uplink (UL) resource obtaining procedure, and wherein the RRC procedure is one selecting from an RRC-based procedure and an RRC-less procedure, and the UL resource obtaining procedure is one selecting from a random access (RA) procedure and a configured grant (CG) procedure. At step 1103, the UE initiates small data transmission in the UE INACTIVE state following the selected ISDT initiation procedure. At step 1104, the UE performs one or more data transmissions in the UE INACTIVE state.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
verifying, by a user equipment (UE), a set of preconfigured inactive small data transmission (ISDT) conditions in a wireless network, wherein the UE is configured to perform small data transmission in a UE INACTIVE state when the set of preconfigured ISDT conditions are met;
selecting an ISDT initiation procedure based on one or more sets of selection conditions, wherein the one or more sets of selection conditions comprise a set of selection conditions for a radio resource control (RRC) procedure and a set of selection conditions for an uplink (UL) resource obtaining procedure, and wherein the RRC procedure is one selecting from an RRC-based procedure and an RRC-less procedure, and the UL resource obtaining procedure is one selecting from a random access (RA) procedure and a configured grant (CG) procedure;
initiating small data transmission in the UE INACTIVE state following the selected ISDT initiation procedure; and
performing one or more data transmissions in the UE INACTIVE state.

2. The method of claim 1, wherein the UE resumes RRC connection and enters CONNECTED state without the ISDT when the verifying of the set of preconfigured ISDT conditions failed.

3. The method of claim 1, wherein the set of preconfigured ISDT conditions comprises, a data volume is smaller than or equal to a preconfigured IDST data volume threshold, the UE has a valid Inactive AS context, no fallback indication has been received, and ISDT is supported by the wireless network.

4. The method of claim 3, wherein the set of preconfigured ISDT conditions further comprises a reference signal received power (RSRP) is greater than or equal to a preconfigured RSRP threshold.

5. The method of claim 1, wherein the set of selection conditions for the RRC procedure is to select the RRC-less procedure when RRC-less conditions are met, otherwise the RRC-based procedure is selected, and wherein the RRC-less conditions comprise RRC-less for ISDT is supported by the network, no security update is needed, and no RRC reconfiguration is needed.

6. The method of claim 1, wherein the set of selection conditions for the UL resource obtaining procedure is to select the CG procedure when CG conditions are met, otherwise the RA procedure is selected, and wherein the CG conditions comprise valid preconfigured UL resources, valid time alignment, and a data volume is smaller than or equal to a preconfigured CG data volume threshold.

7. The method of claim 6, wherein when the RA procedure is selected based on the selection conditions for the UL resource obtaining procedure, a two-step RA procedure is selected when a RSRP is larger than a preconfigured two-step RSRP threshold.

8. The method of claim 1, wherein the ISDT initiation procedure is one selecting from an RRC-based RA procedure, an RRC-based CG procedure, an RRC-less RA procedure, and an RRC-less CG procedure.

9. The method of claim 8, wherein one set of selection conditions is used to select the ISDT initiation procedure.

10. The method of claim 9, wherein the RRC-less CG procedure is selected when a set of RRC-less CG conditions is met, the RRC-based CG procedure is selected when a set of RRC-based CG conditions is met, a RRC-less RA procedure is selected when a set of RRC-less RA conditions is met, and the RRC-based RA procedure is selected when a set of RRC-based RA conditions is met, and wherein the set of RRC-less CG conditions comprise valid preconfigured UL resources, valid time alignment, a data volume is smaller than or equal to a preconfigured CG data volume threshold, and RRC-less ISDT is supported; the set of RRC-based CG conditions comprise valid preconfigured UL resources, valid time alignment, and a data volume is smaller than or equal to a preconfigured CG data volume threshold; the set of RRC-less RA conditions comprise no security update is needed, no reconfiguration is needed, and RRC-less ISDT is supported, and a data volume is smaller than or equal to a preconfigured IDST data volume threshold; the set of RRC-based RA conditions comprise a data volume is smaller than or equal to a preconfigured IDST data volume threshold and ISDT is supported.

11. The method of claim 8, wherein the ISDT initiation procedure is selected from the RRC-based RA procedure and the RRC-based CG procedure when the RRC-less procedure for ISDT is not supported by the wireless network.

12. A user equipment (UE) comprising:
a radio frequency (RF) transceiver that transmits and receives radio signals in a wireless network;
an inactive small data transmission (ISDT) verification module that verifies a set of preconfigured ISDT conditions in the wireless network, wherein the UE is configured to perform small data transmission in a UE INACTIVE state when the set of preconfigured ISDT conditions are met;
a selection module that selects an ISDT initiation procedure based on one or more sets of selection conditions, wherein the one or more sets of selection conditions comprise a set of selection conditions for a radio resource control (RRC) procedure and a set of selection conditions for an uplink (UL) resource obtaining procedure, and wherein the RRC procedure is one selecting from an RRC-based procedure and an RRC-less procedure, and the UL resource obtaining procedure is one selecting from a random access (RA) procedure and a configured grant (CG) procedure;
an initiation module that initiates small data transmission in the UE INACTIVE state following the selected ISDT initiation procedure; and
an ISDT module that performs one or more data transmissions in the UE INACTIVE state.

13. The UE of claim 12, wherein the UE resumes an RRC connection and enters a CONNECTED state without the ISDT when the verifying of the set of preconfigured ISDT conditions failed.

14. The UE of claim 12, wherein the set of preconfigured ISDT conditions comprises, a data volume is smaller than or equal to a preconfigured ISDT data volume threshold, the UE has a valid Inactive AS context, no fallback indication has been received, and ISDT is supported by the wireless network.

15. The UE of claim 14, wherein the set of preconfigured ISDT conditions further comprises a reference signal received power (RSRP) is greater than or equal to a preconfigured RSRP threshold.

16. The UE of claim 12, wherein the set of selection conditions for the RRC procedure is to select the RRC-less procedure when RRC-less conditions are met, otherwise the RRC-based procedure is selected, and wherein the RRC-less conditions comprise RRC-less for ISDT is supported by the network, no security update is needed, and no reconfiguration is needed.

17. The UE of claim 12, wherein the set of selection conditions for the UL resource obtaining procedure is to select the CG procedure when CG conditions are met, otherwise the RA procedure is selected, and wherein the CG conditions comprise valid preconfigured UL resources, valid time alignment, and a data volume is smaller than or equal to a preconfigured CG data volume threshold.

18. The UE of claim 17, wherein when the RA procedure is selected based on the selection conditions for the UL resource obtaining procedure, a two-step RA procedure is selected when a RSRP is larger than a preconfigured two-step RSRP threshold.

19. The UE of claim 12, wherein the ISDT initiation procedure is one selecting from an RRC-based RA procedure, an RRC-based CG procedure, an RRC-less RA procedure, and an RRC-less CG procedure.

20. The UE of claim 19, wherein the RRC-less CG procedure is selected when a set of RRC-less CG conditions is met, the RRC-based CG procedure is selected when a set of RRC-based CG conditions is met, a RRC-less RA procedure is selected when a set of RRC-less RA conditions is met, and the RRC-based RA procedure is selected when a set of RRC-based RA conditions is met, and wherein the set of RRC-less CG conditions comprise valid preconfigured UL resources, valid time alignment, a data volume is smaller than or equal to a preconfigured CG data volume threshold, and RRC-less ISDT is supported; the set of RRC-based CG conditions comprise valid preconfigured UL resources, valid time alignment, and a data volume is smaller than or equal to a preconfigured CG data volume threshold; the set of RRC-less RA conditions comprise no security update is needed, no reconfiguration is needed, and RRC-less ISDT is supported, and a data volume is smaller than or equal to a preconfigured IDST data volume threshold; the set of RRC-based RA conditions comprise a data volume is smaller than or equal to a preconfigured IDST data volume threshold and ISDT is supported.
